(19) United States
(12) Patent Application Publication
(10) Pub. No.: US 2013/0041702 A1
(43) Pub. Date: Feb. 14, 2013

(54) FORECASTING METHOD AND SYSTEM

(71) Applicant: Anjelika Votintseva, Ottobrunn (DE)

(72) Inventor: Anjelika Votintseva, Ottobrunn (DE)

(21) Appl. No.: 13/204,995

(22) Filed: Aug. 8, 2011

(51) Int. Cl. G06F 15/18; G06Q 10/00

(52) U.S. Cl. 705/7.11; 706/12

(57) ABSTRACT

A method includes steps for gathering forecast prognoses from a plurality of forecasting assessment participants and for weighting the participant specific forecast prognoses with a participant specific weighting factor. The participant specific weighting factor is adjusted according to a deviation of the participant specific forecast prognoses from actual outcomes of the forecasting assessments. A machine readable medium includes instructions for executing a forecasting method. A forecasting system includes a computer system and remote computers being coupled to the computer system, the computer system being configured to perform a forecasting method.

### TECHNICAL FIELD

The present invention relates to methods, devices and systems of forecasting, in particular to methods of using individual forecasting prognoses to generate an accumulated forecasting estimate.

### BACKGROUND

Forecasting in an uncertain environment is complex. Most methods are used for financial forecasts such as market development, sales and stock prices. Another area for forecasts is project management. Decision makers may need forecasts only, if there is uncertainty of the future. For complex situations about which there is much uncertainty, the forecast prognoses of experts are no more accurate than the ones of laymen. For judgmental forecasting it may therefore be advantageous to obtain forecast prognoses from a plurality of sources, in particular from experts with diverse knowledge and opinions.

### SUMMARY

According to various embodiments forecasting methods can be provided that combine the prognoses of different forecasting participants. The prognoses may be weighted with participant specific weighting factors before combining the prognoses to an overall prognosis for the respective forecasting assessment.

According to an embodiment, a method may comprise the steps:

providing a first numerical value range for a forecasting variable of a first forecasting assessment to a plurality of assessment participants; gathering a first plurality of participant specific prognoses of the forecasting variable from the plurality of assessment participants; calculating an estimated forecast prognosis on the basis of a sum of the first plurality of participant specific prognoses, the participant specific prognoses being weighted with a participant specific weighting factor; determining an actual outcome of the first forecasting assessment; determining, for each assessment participant, a participant specific deviation of the participant specific prognosis from the actual outcome; and adjusting, for each assessment participant, the participant specific weighting factor according to the determined participant specific deviation.

According to a further embodiment, the method may further comprise: providing a second numerical value range for a forecasting variable of a second forecasting assessment to the plurality of assessment participants; gathering a second plurality of participant specific prognoses of the forecasting variable from the plurality of assessment participants; and calculating an estimated forecast prognosis for the second forecasting assessment on the basis of a sum of the first plurality of participant specific prognoses, the participant specific prognoses being weighted with the adjusted participant specific weighting factor. According to a further embodiment, the prognoses of the assessment participants not having values within the first value range can be excluded from the step of calculating the estimated forecast prognosis. According to a further embodiment, determining the participant specific deviation of the participant specific prognosis may comprise: determining a percentaged deviation of the participant specific prognosis from the actual outcome.

According to a further embodiment, adjusting the participant specific weighting factor may comprise: adding the determined percentaged deviation to the participant specific weighting factor, if the percentaged deviation does not exceed a first predetermined threshold value. According to a further embodiment, the forecasting assessment may comprise one of a financial forecasting assessment, a project costs forecasting assessment and a project time forecasting assessment.

According to another embodiment, a method may comprise the steps: assigning a starting weighting factor to each participant of a plurality of forecasting assessments; providing a plurality of numerical value ranges for forecasting variables of a predetermined plurality of forecasting assessments to the plurality of assessment participants; gathering, for each of the plurality of forecasting assessments, pluralities of participant specific prognoses of the forecasting variables from the plurality of assessment participants; determining actual outcomes of the forecasting assessments; determining, for each assessment participant and for each of the plurality of forecasting assessments, participant specific deviations of the participant specific prognoses from the actual outcome; determining, for each assessment participant, if the participant specific deviations are below a predetermined threshold value; and adjusting, for the assessment participants whose participant specific deviations have all been determined as being below the predetermined threshold value, the participant specific starting weighting factor according to the plurality of determined participant specific deviations.

According to a further embodiment of the above method, determining the participant specific deviations of the participant specific prognoses may comprise: determining a plurality of percentaged deviations of the plurality of participant specific prognoses from the actual outcomes. According to a further embodiment of the above method, adjusting the participant specific weighting factor may comprise: adding each of the plurality of the determined percentaged deviations to the participant specific starting weighting factor.

According to yet another embodiment, a machine readable medium may comprise instructions for: providing a first numerical value range for a forecasting variable of a first forecasting assessment to a plurality of assessment participants; gathering a first plurality of participant specific prognoses of the forecasting variable from the plurality of assessment participants; calculating an estimated forecast prognosis on the basis of a sum of the first plurality of participant specific prognoses, the participant specific prognoses being weighted with a participant specific weighting factor; determining an actual outcome of the first forecasting assessment; determining, for each assessment participant, a participant specific deviation of the participant specific prognosis from the actual outcome; and adjusting, for each assessment participant, the participant specific weighting factor according to the determined participant specific deviation.

According to yet another embodiment, a forecasting system may comprise: a computer system; a plurality of remote computers being coupled to the computer system via a network, wherein the computer is configured to provide a first numerical value range for a forecasting variable of a first forecasting assessment to the plurality of remote computers, wherein the computer is configured to gathering a first plurality of participant specific prognoses of the forecasting variable from a plurality of assessment participants inputting the first plurality of participant specific prognoses to the plurality of remote computers, wherein the computer is configured to calculate an estimated forecast prognosis on the basis of a sum of the first plurality of participant specific prognoses, the participant specific prognoses being weighted with a participant specific weighting factor, wherein the computer is configured to determine an actual outcome of the first forecasting assessment, wherein the computer is configured to determine, for each assessment participant, a participant specific deviation of the participant specific prognosis from the actual outcome, and wherein the computer is configured to adjust, for each assessment participant, the participant specific weighting factor according to the determined participant specific deviation.

According to a further embodiment of the forecasting system, the computer system may further comprise: a storage medium configured to store the plurality of participant specific weighting factors, the plurality of participant specific prognoses and the actual outcomes of the forecasting assessments. According to a further embodiment of the forecasting system, the computer system may further be configured to submit the adjusted participant specific weighting factor to a respective one of the plurality of remote computers for each of the assessment participants to view the adjusted participant specific weighting factor.

According to a further embodiment of the forecasting system the computer system may further be configured to assign an assessment specific weighting factor to each assessment participant, the assessment specific weighting factor being specific for each assessment participant and each field of topic of forecasting assessments.

### BRIEF DESCRIPTION OF THE DRAWINGS

The accompanying drawings are included to provide a further understanding of the various embodiments and are incorporated in and constitute a part of this specification. The drawings illustrate the embodiments and together with the description serve to explain the principles of the invention. Other embodiments and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates an embodiment of a method of generating a forecasting model.

FIG. 2 schematically illustrates another embodiment of a method of generating a forecasting model.

FIG. 3 schematically illustrates a further embodiment of a system operable to perform a method of generating a forecasting model.

### DETAILED DESCRIPTION

By assigning participant specific weighting factors, each participant may be given a particular weight which relates to the ability and accuracy of the participant to estimate an outcome of the forecasting assessment. The participant specific weighting factors may be adjusted according to the forecasting history, in particular the previous forecasting precision of each participant based on the deviations of the participant specific prognoses from actual outcomes of previous forecasting assessments.

The weighting factors and their adjustments may be communicated to the participants in order to appeal to the competitive awareness of the participants. Participants will advantageously try to improve their weighting factor, thus heightening the motivation to provide forecasting prognoses with improved accuracy.

The weighting factors may be adjusted dynamically during the course of subsequent forecasting assessments, thus taking into account the current ability of forecasting assessment participants to accurately make a forecasting prognosis. The more accurate a participant has been able to make forecasting prognosis, the higher his weighting factors will become with respect to the remaining participants. Therefore, the labelling of so-called “experts” will be performed on an unbiased basis, merely on the merits of the precision of the forecasting results in previous forecasting assessments.

According to an embodiment a method may comprise the steps of providing a first numerical value range for a forecasting variable of a first forecasting assessment to a plurality of assessment participants, gathering a first plurality of participant specific prognoses of the forecasting variable from the plurality of assessment participants, calculating an estimated forecast prognosis on the basis of a sum of the first plurality of participant specific prognoses, the participant specific prognoses being weighted with an participant specific weighting factor, determining an actual outcome of the first forecasting assessment, determining, for each assessment participant, a participant specific deviation of the participant specific prognosis from the actual outcome, and adjusting, for each assessment participant, the participant specific weighting factor according to the determined participant specific deviation.

In one embodiment, the method may further comprise the steps of providing a second numerical value range for a forecasting variable of a second forecasting assessment to the plurality of assessment participants, gathering a second plurality of participant specific prognoses of the forecasting variable from the plurality of assessment participants, and calculating an estimated forecast prognosis for the second forecasting assessment on the basis of a sum of the first plurality of participant specific prognoses, the participant specific prognoses being weighted with the adjusted participant specific weighting factor. This increases the accuracy of subsequent forecasts, since more precise forecasting assessment participants are dynamically given more weight than other participants. The overall accuracy of the prognosis of further forecasting assessments will therefore be improved.

In another embodiment, in the method the prognoses of the assessment participants not having values within the first value range may be excluded from the step of calculating the estimated forecast prognosis. This prevents participants which do not comply with reasonable forecasting prognosis values from deteriorating the overall accuracy of the forecasting assessment in question.

In yet another embodiment, the step of determining the participant specific deviation of the participant specific prognosis may comprise the step of determining a percentaged deviation of the participant specific prognosis from the actual outcome. This measure allows for normalization of the forecasting assessments relative to each other, irrespective of the numerical value ranges provided for each forecasting variable.

In yet another embodiment, the step of adjusting the participant specific weighting factor may comprise the step of adding the determined percentaged deviation to the participant specific weighting factor, if the percentaged deviation does not exceed a first predetermined threshold value. This allows for the selective increase of weighting factors, if the respective forecasting prognosis lies within a predetermined deviation range.

In another embodiment, in the method the forecasting assessment may comprise one of a financial forecasting assessment, a project costs forecasting assessment and a project time forecasting assessment.

According to other embodiments, forecasting assessment participants can be rewarded which maintain high forecasting precision over an extended period of subsequent forecasting assessments. The reward may include adjusting the participant specific weighting factors not only by an increase that can be attributed to the last evaluated forecasting assessment, but rather a heightened increase that is attributed to all previous forecasting assessments in which the participant showed very high forecasting accuracy in a row.

According to other embodiments a method may comprise the steps of assigning a starting weighting factor to each participant of a plurality of forecasting assessments, providing a plurality of numerical value ranges for forecasting variables of a predetermined plurality of forecasting assessments to the plurality of assessment participants, gathering, for each of the plurality of forecasting assessments, pluralities of participant specific prognoses of the forecasting variables from the plurality of assessment participants, determining actual outcomes of the forecasting assessments, determining, for each assessment participant and for each of the plurality of forecasting assessments, participant specific deviations of the participant specific prognoses from the actual outcome, determining, for each assessment participant, if the participant specific deviations are below a predetermined threshold value, and adjusting, for the assessment participants whose participant specific deviations have all been determined as being below the predetermined threshold value, the participant specific starting weighting factor according to the plurality of determined participant specific deviations.

In yet another embodiment, the step of determining the participant specific deviations of the participant specific prognoses may comprise the step of determining a plurality of percentaged deviations of the plurality of participant specific prognoses from the actual outcomes.

In yet another embodiment, the step of adjusting the participant specific weighting factor may comprise the step of adding each of the plurality of the determined percentaged deviations to the participant specific starting weighting factor.

According to yet other embodiments, a machine readable medium may comprise instructions for providing a first numerical value range for a forecasting variable of a first forecasting assessment to a plurality of assessment participants, gathering a first plurality of participant specific prognoses of the forecasting variable from the plurality of assessment participants, calculating an estimated forecast prognosis on the basis of a sum of the first plurality of participant specific prognoses, the participant specific prognoses being weighted with an participant specific weighting factor, determining an actual outcome of the first forecasting assessment, determining, for each assessment participant, a participant specific deviation of the participant specific prognosis from the actual outcome, and adjusting, for each assessment participant, the participant specific weighting factor according to the determined participant specific deviation.

According to yet other embodiments, a forecasting system may comprise a computer system, a plurality of remote computers being coupled to the computer system via a network, wherein the computer is configured to provide a first numerical value range for a forecasting variable of a first forecasting assessment to the plurality of remote computers, wherein the computer is configured to gathering a first plurality of participant specific prognoses of the forecasting variable from a plurality of assessment participants inputting the first plurality of participant specific prognoses to the plurality of remote computers, wherein the computer is configured to calculate an estimated forecast prognosis on the basis of a sum of the first plurality of participant specific prognoses, the participant specific prognoses being weighted with an participant specific weighting factor, wherein the computer is configured to determine an actual outcome of the first forecasting assessment, wherein the computer is configured to determine, for each assessment participant, a participant specific deviation of the participant specific prognosis from the actual outcome, and wherein the computer is configured to adjust, for each assessment participant, the participant specific weighting factor according to the determined participant specific deviation. This system may advantageously allow for the implementation of the forecasting system in an intranet or the internet as a collaboration tool between, for example, co-workers of a company, project team members or the like. Such a system may be used to aggregate a large number of forecasting prognoses accurately, reliably, automatically and individually accountable to each participant. By means of timestamps and references to individual participants a record of forecasting prognoses for each forecasting assessment and each forecasting participant may be kept.

In one embodiment , the computer system may further comprise a storage medium configured to store the plurality of participant specific weighting factors, the plurality of participant specific prognoses and the actual outcomes of the forecasting assessments. This storage medium advantageously allows for the build up of a database in order to keep historical records of a manifold of forecasting prognoses for a row of forecasting assessments.

In another embodiment, the computer system may further be configured to submit the adjusted participant specific weighting factor to a respective one of the plurality of remote computers for each of the assessment participants to view the adjusted participant specific weighting factor. This enables each participant to keep track of his personal forecasting record which may serve as incentive to increase the individual forecasting accuracy. The incentive system of the weighting factors may be coupled to other incentive systems such as monetary or career related incentive systems.

In yet another embodiment, the computer system may further configured to assign an assessment specific weighting factor to each assessment participant, the assessment specific weighting factor being specific for each assessment participant and each field of topic of forecasting assessments. This allows participants to be assigned different levels of expertise in different fields. The motivation of participants may in this case be the overall maximization of the cumulative value of all participant specific weighting factors.

Although specific embodiments have been illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

Embodiments may include methods and processes that may be embodies within machine readable instructions provided by a machine readable medium, the machine readable medium including, but not being limited to devices, apparatuses, mechanisms or systems being able to store information which may be accessible to a machine such as a computer, a calculating device, a processing unit, a networking device, a portable computer, a microprocessor or the like. The machine readable medium may include volatile or non-volatile media as well as propagated signals of any form such as electrical signals, digital signals, logical signals, optical signals, acoustical signals, acousto-optical signals or the like, the media being capable of conveying information to a machine.

In the following, reference is made to methods and method steps, which are schematically and exemplarily illustrated in flow charts and block diagrams. It should be understood that the methods described in conjunction with those illustrative drawings may easily be performed by embodiments of systems, apparatuses and/or devices as well. In particular, it should be obvious that the systems, apparatuses and/or devices capable of performing the detailed block diagrams and/or flow charts are not necessarily limited to the systems, apparatuses and/or devices shown and detailed herein below, but may rather be different systems, apparatuses and/or devices.

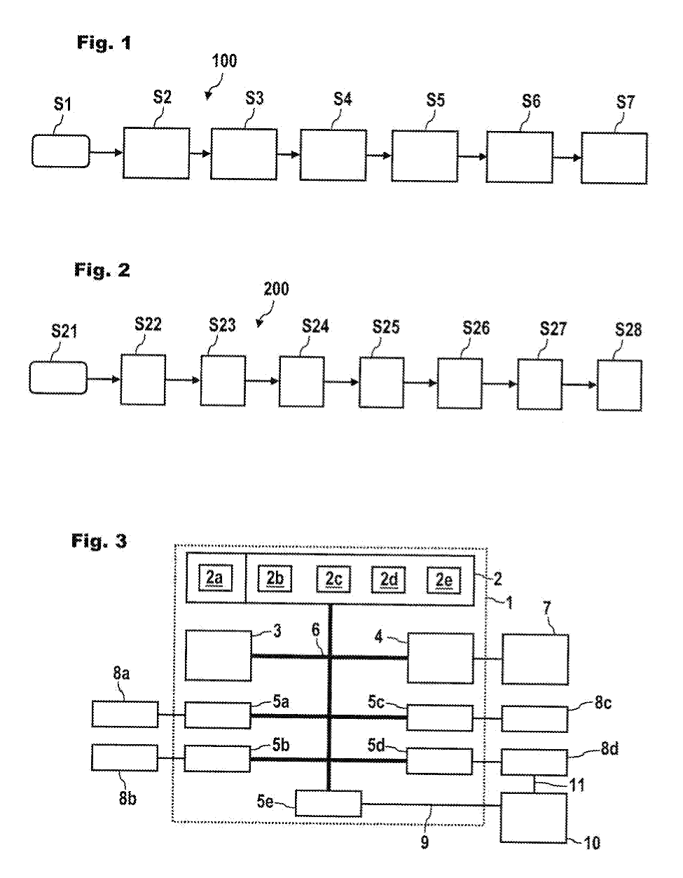

FIG. 1 illustrates a forecasting method 100. The method 100 may start at S1. In step S2, a first numerical value range Pₘᵢₙ to Pₘₐₓ for a forecasting variable P of a first forecasting assessment is provided to a plurality of assessment participants. Each assessment participant may be given an unambiguous participant index I out of a predetermined identification index range. In step S3, a first plurality of participant specific prognoses P_{I} of the forecasting variable P is gathered from the plurality of assessment participants I.

In step S4, an estimated forecast prognosis Q is calculated on the basis of a sum of the first plurality of participant specific prognoses P_{I}, the participant specific prognoses being weighted with a participant specific weighting factor k_{I}. The formula for calculating the estimated forecast prognosis Q may be

Q=(Σᵢ(Pᵢkᵢ))/(Σi(kᵢ)), (1)

wherein the sum is calculated for every participant I of the forecasting assessment. The initial values for k_{I} may be the same for all participants I or may be given by an expert board depending on the expert level of the respective participants. The higher the weighting factor k_{I}, the more weight the forecasting prognosis of the respective participant I will be given when calculating the overall estimated forecast prognosis Q. The overall estimated forecast prognosis Q is normalized to the sum of all weighting factors in order to make the overall estimated forecast prognosis Q independent of the number of participants I which may deviate between different forecasting assessments.

In step S5, an actual outcome R of the first forecasting assessment is determined. The actual outcome R may be determined once the assessment under forecast has become reality and the actually resulting values of the forecasting variable may be observed or detected.

In step S6, for each assessment participant, a participant specific deviation D_{I} of the participant specific prognosis P_{I} from the actual outcome R is determined. The participant specific deviation D_{I} may be calculated as function F(D_{I}, R). In a particular embodiment, the participant specific deviation D_{I} may be calculated as

D_{I}=|(R−P_{I})/R| (2)

so that the participant specific deviation D_{I} is a percentaged value of the absolute deviation of the participant specific prognosis P_{I} from the actual outcome R.

In step S7, for each assessment participant, the participant specific weighting factor k_{I} is adjusted according to the determined participant specific deviation D_{I}. For example, the adjustment value d_{I} may be determined as

d_{I}=1−D_{I}. (3)

In that case, the adjustment of the weighting factor k_{I} may depend on the level of accuracy for each assessment participant I. For example, the previous participant specific weighting factor k_{I}⁰ may be adjusted to be

k_{I}¹=k_{I}⁰+d_{I}, (4)

if the participant specific deviation D_{I} is smaller than a first threshold value T, for example, a predetermined percentage of the value of the actual outcome R. In one embodiment, the threshold value may be 10%.

It may be possible to providing a second and further numerical value ranges for a forecasting variable of a second and further forecasting assessments to the plurality of assessment participants, similar to step S2. Similar to step S3, a second and further pluralities of participant specific prognoses of the forecasting variable may be gathered from the plurality of assessment participants. Then, similar to step S4, an estimated forecast prognosis for the second and the further forecasting assessments may be calculated on the basis of a sum of the second or further pluralities of participant specific prognoses, the participant specific prognoses being weighted with the adjusted participant specific weighting factors.

This means that the adjusted participant specific weighting factors k_{I} may serve as new participant specific weighting factors k_{I} for the purposes of the adjustments according to equation (4). In this way, the participant specific weighting factors k_{I} may be adjusted iteratively, based on how accurate the assessment participants are able to forecast the subsequent forecasting variables.

The method 100 may be used for the assessment of financial forecasting assessments, project costs forecasting assessments, project time forecasting assessments or other forecasting assessments. For example, the forecasting assessments may also relate to weather forecasting, sports forecasting, political polls, stock market forecasts or the like.

FIG. 2 illustrates a forecasting method 200. The method 200 may start at S21. In a step S22, a starting weighting factor k_{I}⁰ may be assigned to each participant I of a plurality of forecasting assessments n. In a step S23, a plurality of numerical value ranges for forecasting variables Pⁿ of a predetermined plurality of forecasting assessments may be provided to the plurality of assessment participants I. In a step S24, for each of the plurality of forecasting assessments n, pluralities of participant specific prognoses P_{I}ⁿ of the forecasting variables Pⁿ may be gathered from the plurality of assessment participants I.

In a step S25, the actual outcomes Rⁿ of the forecasting assessments n may be determined. The steps S22, S23, S24 and S25 may be performed in an analog way to the steps S2, S3 and S4, respectively, as detailed with regard to method 100 shown in FIG. 1.

In a step S26, for each assessment participant I and for each of the plurality of forecasting assessments n, participant specific deviations D_{I}ⁿ of the participant specific prognoses P_{I}ⁿ from the actual outcome Rⁿ may be calculated. The deviations may, for example, be calculated using similar formulae as detailed with respect to step S6 of method 100 and equation (2).

In a step S27, for each assessment participant, it may be determined, if the participant specific deviations D_{I}ⁿ are below a predetermined threshold value T. The predetermined threshold value may be a percentage of the respective values of the actual outcomes Rⁿ of each forecasting assessment n. In one embodiment, the threshold value T may be 5%. If a participant I was able to maintain a very high precision for his forecasting prognosis P_{I}ⁿ throughout the series of subsequent forecasting assessments n, it may be provided that the respective participant I is rewarded more than a participant I who was not able to stay below the threshold value T with his forecasting prognoses during the series of forecasting assessments n.

In order to realize the higher reward, in a step S28, for the assessment participants I whose participant specific deviations D_{I}ⁿ have all been determined as being below the predetermined threshold value T, the participant specific starting weighting factor k_{I}⁰ may be adjusted according to the plurality of determined participant specific deviations D_{I}ⁿ. In one embodiment, the adjustment values d_{I}ⁿ which may be defined as d_{I}ⁿ=1−D_{I}ⁿ may be summed up over all forecasting assessments n and added to the participant specific starting weighting factor k_{I}⁰:

k_{I}ⁿ=k_{I}⁰+Σₙ (d_{I}ⁿ) (5)

Such rising value of a participant I, which may be automatically obtained from the history of predictions, may motivate participants further to take particular attention to the quality and accuracy of their prognoses, to raise their expertise and become more interested in their respective field of expertise. Other incentive systems may be coupled to the weighting factor incentive system, such as monetary or career related incentive systems.

It may be useful to degrade the participant specific weighting factor k_{I}, if the forecasting prognosis of a participant is too far away from the actual outcome in order to discourage participants from simply guessing or the reflect the lost forecast competence in a particular field. In one embodiment, if the participant specific deviation D_{I} for a previous forecast assessment is determined to be above a second threshold value G, the participant specific weighting factor k_{I} may be adjusted by reducing the previous participant specific weighting factor k_{I} by a fraction of the adjustment value d_{I}. In one embodiment, the second threshold value may be 70%. In one embodiment, the fraction of the adjustment value d_{I} may be a tenth or a fifth or half. For example, the reduced participant specific weighting factor k_{I}ⁿ may be calculated on the basis of the previous participant specific weighting factor k_{I}ⁿ⁻¹ by

k_{I}ⁿ=k_{I}ⁿ⁻¹−d_{I}/f, (6)

wherein f is the fraction of reduction and d_{I} the reduction value for the forecasting assessment n−1. This reduction according to equation (6) may for example only apply, where the adjustment value d_{I} is a value between −1 and 1. For adjustment values d_{I} that lie beyond that range, the reduced participant specific weighting factor k_{I}ⁿ may be calculated on the basis of the previous participant specific weighting factor k_{I}ⁿ⁻¹ by

k_{I}ⁿ=k_{I}ⁿ⁻¹/d_{I}. (7)

It may be provided that the reduced participant specific weighting factor k_{I}ⁿ may not drop below an initial starting weighting factor k_{I}⁰, which may for example be the weighting factor initially assigned to each newly starting participant in forecasting assessments.

In the embodiment shown in FIG. 3, a hardware and operating environment is provided upon which one or more embodiments of the present disclosure may operate.

As shown in FIG. 3, one or more embodiments of the hardware and operating environment may include a general purpose computing device in the form of a computer 1, for example a personal computer, a workstation, a server or a similar device, including one or more processing units 3, a system memory 2, and a system bus 6 that operatively couples various system components including the system memory 2 to the processing unit 3. There may be only one or there may be more than one processing unit 3, such that the processor of the computer 1 comprises a single central processing unit, or a plurality of processing units, commonly referred to as a multiprocessor or parallel-processor environment. In various embodiments, which may comprise some but not all of the foregoing embodiments, the computer 1 may be a conventional computer, a distributed computer, or any other type of computer.

The system bus 6 may be any of several types of bus structures including a memory bus or memory controller, a peripheral bus, and a local bus using any of a variety of bus architectures. The system memory may also be referred to as simply the memory, and, in some but not necessarily all embodiments, includes read-only memory and/or random-access memory. A basic input/output system program 2a, containing the basic routines that help to transfer information between elements within the computer 1, such as during start-up, may be stored in a read-only memory. The computer 1 may further be coupled to a hard disk drive 8a for reading from and writing to a hard disk, a magnetic disk drive 8b for reading from or writing to a removable magnetic disk, and/or an optical disk drive 8c for reading from or writing to a removable optical disk such as a CD ROM or other optical media.

The hard disk drive 8a, magnetic disk drive 8b, and optical disk drive 8c may couple with a hard disk drive interface 5a, a magnetic disk drive interface 5b, and an optical disk drive interface 5c of the computer 1, respectively. The drives 5a, 5b, 5c and their associated computer-readable media provide non-volatile storage of computer-readable instructions, data structures, program modules and other data for the computer 1. It should be appreciated by one skilled in the art that any type of computer-readable media which is able to store data that is accessible by a computer, such as magnetic cassettes, flash memory cards, digital video disks, random access memories, read only memories, universal serial bus flash memory sticks, and the like, may be used in the exemplary operating environment.

A plurality of program modules may be stored on the hard disk 8a, magnetic disk, optical disk, read-only memory, and/or random access memory, including an operating system 2b, one or more application programs 2c, other program modules 2d, and program data 2e. A plug-in containing a security transmission engine may be resident on any one or number of these computer-readable media.

A user may enter commands and information into computer 1 through input devices such as a keyboard, a pointing device, a microphone, a joystick, a game pad, a scanner, or the like. These input devices are often connected to the processing unit 3 through a serial port interface 5d that is coupled to the system bus 6, but can be connected by other interfaces, such as a parallel port, game port, or a universal serial bus port. A monitor 7 or other type of display device may also be connected to the system bus 6 via an interface, such as a video adapter 4. The monitor 7 may be able display a graphical user interface for the user. In addition to the monitor 7, the computer 1 may be coupled to other peripheral output devices, such as speakers, printers, and other not explicitly mentioned devices.

The computer 1 may operate in a networked environment using logical connections to one or more remote computers or servers, such as remote computer 10. These logical connections are achieved by a communication device coupled to or a part of the computer 1; the examples in the disclosure are not limited to a particular type of communications device. The remote computer 10 can be another computer, a server, a router, a network personal computer, a client, a peer device or other common network node, and typically includes many or all of the elements described above input/output devices explained with respect to the computer 1. The logical connections include a local area network 9 and/or a wide area network 11. Such networking environments are commonplace in office networks, enterprise-wide computer networks, intranets and the internet, which are all types of networks.

When used in a local area networking environment, the computer 1 may be connected to the local area network 9 through a network interface or adapter 5e, which is one type of communications device. In some but not necessarily all embodiments, when used in a wide are networking environment, the computer 1 typically is coupled to a modem 8d or any other type of communications device, for example a wireless transceiver, for establishing communications over the wide-area network 11, such as the internet. The modem 8d, which may be internal or external, is connected to the system bus 6 via the serial port interface 5d. In a networked environment, program modules depicted relative to the computer 1 may be stored in a remote memory storage device of remote computer or server 10. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter may lie in less than all features of a single disclosed example. Thus the following claims are hereby incorporated into the detailed description as examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to one skilled in the art upon reviewing the above specification. The scope of the invention should, therefore, be determined with reference to the appended claims, along with the full scope of equivalents to which such claims are entitled. Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

### LIST OF REFERENCE SIGNS

1 Computer

2 System memory

2a Basic input/output system program

2b System program

2c Application programs

2d Program modules

2e Program data

3 Processing unit

4 Video adapter

5a Hard disk drive interface

5b Magnetic disk drive interface

5c Optical disk drive interface

5d Serial port interface

6 System bus

7 Monitor

8a Hard disk drive

8b Magnetic disk drive

8c Optical disk drive

8d Modem

9 Local area network

10 Remote computer

11 Wide area network

100 Method

200 Method

S1 Method step

S2 Method step

S3 Method step

S4 Method step

S5 Method step

S6 Method step

S7 Method step

S21 Method step

S22 Method step

S23 Method step

S24 Method step

S25 Method step

S26 Method step

S27 Method step

S28 Method step

What is claimed is:

1. A method comprising the steps:
providing a first numerical value range for a forecasting variable of a first forecasting assessment to a plurality of assessment participants;
gathering a first plurality of participant specific prognoses of the forecasting variable from the plurality of assessment participants;
calculating an estimated forecast prognosis on the basis of a sum of the first plurality of participant specific prognoses, the participant specific prognoses being weighted with a participant specific weighting factor;
determining an actual outcome of the first forecasting assessment;
determining, for each assessment participant, a participant specific deviation of the participant specific prognosis from the actual outcome; and
adjusting, for each assessment participant, the participant specific weighting factor according to the determined participant specific deviation.

2. The method according to claim 1, further comprising:
providing a second numerical value range for a forecasting variable of a second forecasting assessment to the plurality of assessment participants;
gathering a second plurality of participant specific prognoses of the forecasting variable from the plurality of assessment participants; and
calculating an estimated forecast prognosis for the second forecasting assessment on the basis of a sum of the first plurality of participant specific prognoses, the participant specific prognoses being weighted with the adjusted participant specific weighting factor.

3. The method according to claim 1, wherein the prognoses of the assessment participants not having values within the first value range are excluded from the step of calculating the estimated forecast prognosis.

4. The method according to claim 1, wherein determining the participant specific deviation of the participant specific prognosis comprises:
determining a percentaged deviation of the participant specific prognosis from the actual outcome.

5. The method according to claim 4, wherein adjusting the participant specific weighting factor comprises:
adding the determined percentaged deviation to the participant specific weighting factor, if the percentaged deviation does not exceed a first predetermined threshold value.

6. The method according to claim 1, wherein the forecasting assessment comprises one of a financial forecasting assessment, a project costs forecasting assessment and a project time forecasting assessment.

7. A method comprising the steps of:
assigning a starting weighting factor to each participant of a plurality of forecasting assessments;
providing a plurality of numerical value ranges for forecasting variables of a predetermined plurality of forecasting assessments to the plurality of assessment participants;
gathering, for each of the plurality of forecasting assessments, pluralities of participant specific prognoses of the forecasting variables from the plurality of assessment participants;
determining actual outcomes of the forecasting assessments;
determining, for each assessment participant and for each of the plurality of forecasting assessments, participant specific deviations of the participant specific prognoses from the actual outcome;
determining, for each assessment participant, if the participant specific deviations are below a predetermined threshold value; and
adjusting, for the assessment participants whose participant specific deviations have all been determined as being below the predetermined threshold value, the participant specific starting weighting factor according to the plurality of determined participant specific deviations.

8. The method according to claim 7, wherein determining the participant specific deviations of the participant specific prognoses comprises:
determining a plurality of percentaged deviations of the plurality of participant specific prognoses from the actual outcomes.

9. The method according to claim 8, wherein adjusting the participant specific weighting factor comprises:
adding each of the plurality of the determined percentaged deviations to the participant specific starting weighting factor.

10. A machine readable medium storing instructions, which when executed on a processor provide for:
providing a first numerical value range for a forecasting variable of a first forecasting assessment to a plurality of assessment participants;
gathering a first plurality of participant specific prognoses of the forecasting variable from the plurality of assessment participants;
calculating an estimated forecast prognosis on the basis of a sum of the first plurality of participant specific prognoses, the participant specific prognoses being weighted with a participant specific weighting factor;
determining an actual outcome of the first forecasting assessment;
determining, for each assessment participant, a participant specific deviation of the participant specific prognosis from the actual outcome; and
adjusting, for each assessment participant, the participant specific weighting factor according to the determined participant specific deviation.

11. The machine readable medium according to claim 10, further comprising instruction which when executed on the processor provide for:
providing a second numerical value range for a forecasting variable of a second forecasting assessment to the plurality of assessment participants;
gathering a second plurality of participant specific prognoses of the forecasting variable from the plurality of assessment participants; and
calculating an estimated forecast prognosis for the second forecasting assessment on the basis of a sum of the first plurality of participant specific prognoses, the participant specific prognoses being weighted with the adjusted participant specific weighting factor.

12. The machine readable medium according to claim 10, wherein the prognoses of the assessment participants not having values within the first value range are excluded from the step of calculating the estimated forecast prognosis.

13. The machine readable medium according to claim 10, wherein determining the participant specific deviation of the participant specific prognosis comprises:
determining a percentaged deviation of the participant specific prognosis from the actual outcome.

14. The machine readable medium according to claim 13, wherein adjusting the participant specific weighting factor comprises:
adding the determined percentaged deviation to the participant specific weighting factor, if the percentaged deviation does not exceed a first predetermined threshold value.

15. The machine readable medium according to claim 10, wherein the forecasting assessment comprises one of a financial forecasting assessment, a project costs forecasting assessment and a project time forecasting assessment.

16. A forecasting system, comprising:
a computer system;
a plurality of remote computers being coupled to the computer system via a network,
wherein the computer is configured to provide a first numerical value range for a forecasting variable of a first forecasting assessment to the plurality of remote computers,
wherein the computer is configured to gathering a first plurality of participant specific prognoses of the forecasting variable from a plurality of assessment participants inputting the first plurality of participant specific prognoses to the plurality of remote computers,
wherein the computer is configured to calculate an estimated forecast prognosis on the basis of a sum of the first plurality of participant specific prognoses, the participant specific prognoses being weighted with a participant specific weighting factor,
wherein the computer is configured to determine an actual outcome of the first forecasting assessment,
wherein the computer is configured to determine, for each assessment participant, a participant specific deviation of the participant specific prognosis from the actual outcome, and
wherein the computer is configured to adjust, for each assessment participant, the participant specific weighting factor according to the determined participant specific deviation.

17. The forecasting system according to claim 11, wherein the computer system further comprises:
a storage medium configured to store the plurality of participant specific weighting factors, the plurality of participant specific prognoses and the actual outcomes of the forecasting assessments.

18. The forecasting system according to claim 11, wherein the computer system is further configured to submit the adjusted participant specific weighting factor to a respective one of the plurality of remote computers for each of the assessment participants to view the adjusted participant specific weighting factor.

19. The forecasting system according to claim 12, wherein the computer system is further configured to assign an assessment specific weighting factor to each assessment participant, the assessment specific weighting factor being specific for each assessment participant and each field of topic of forecasting assessments.
